(19) United States
(12) Patent Application Publication
(10) Pub. No.: US 2025/0180210 A1
(43) Pub. Date: Jun. 5, 2025

(54) A METHOD FOR THE COMBUSTION OF A FUEL GAS

(71) Applicant: Phoenix Biopower IP Services AB, Stockholm (SE)

(72) Inventors: Michael BARTLETT, Ekerö (SE); Felix Matthias GÜTHE, Basel (CH); Hans-Erik HANSSON, Finspång (SE); Panduranga Reddy ALEMELA, Turgi (CH)

(73) Assignee: Phoenix Biopower IP Services AB, Stockholm (SE)

(21) Appl. No.: 18/844,258

(22) PCT Filed: Mar. 6, 2023
(86) PCT No.: PCT/SE2023/050199

§ 371 Date: Sep. 5, 2024

(30) Foreign Application Priority Data
Mar. 9, 2022 (SE) 2250307-2

(51) Int. Cl. F23R 3/16; F23R 3/12

(52) U.S. Cl. CPC F23R 3/16; F23R 3/12

(57) ABSTRACT

A method for the combustion of a fuel gas in a combustor unit, wherein the combustor unit comprises a first swirler; a second swirler downstream of the first swirler; and a combustion chamber arranged downstream of the first and second swirlers. The method comprises: one or more streams of fuel gas mixed with water vapour into one of the first and second swirlers while introducing one or more streams of a gas or gas mixture comprising oxygen into the other one of the first and second swirlers; downstream of the first swirler, forming a gas stream; and in the combustion chamber, producing a flue gas stream from at least oxygen and the fuel gas mixed with water vapour.

### TECHNICAL FIELD

Aspects of the present invention relate to a method for the combustion of a fuel gas in a combustor unit. Further, aspects of the present invention relate to a combustor unit for the combustion of a fuel gas. Further, aspects of the present invention relate to a gas turbine power generation arrangement comprising a combustor unit.

### BACKGROUND

In general, a solid fuel, or fluidized bed, gasifier performs gasification of a solid fuel, for example biomass, and produces or generates a product gas, which may be provided to a combustor of a power generation plant or arrangement, for example a combustor of a gas turbine power generation plant, possibly via a product gas treatment arrangement of said plant. The product gas may also be called fuel gas, or syngas. In general, the combustor produces a flue gas which is provided to a gas expander unit of said plant. The gas expander unit may in turn be mechanically coupled to an electric generator, which generates electric power. However, a fuel gas may be produced in other manners and be provided to a combustor.

### SUMMARY

The inventors of the present invention have found that conventional procedures for the combustion of a fuel gas are not sufficiently flexible and can be further improved. Further, the inventors of the present invention have found that conventional processes of power generation by way of a combustor are not sufficiently flexible and can be further improved. Further, the inventors of the present invention have found that conventional processes of power generation by way of a gas turbine power generation arrangement are not sufficiently flexible and can be further improved.

An object of embodiments of the invention is to provide a solution which mitigates or solves drawbacks and problems of conventional solutions.

The above and further objects are solved by the subject matter of the independent claims. Further advantageous embodiments of the invention can be found in the dependent claims.

According to a first aspect of the invention, the above-mentioned and other objects are achieved with a method for the combustion of a fuel gas in a combustor unit, wherein the combustor unit comprises
a first swirler,
a second swirler, and
a combustion chamber arranged downstream of the first and second swirlers,
wherein the second swirler is arranged downstream of the first swirler,
wherein the method comprises:
introducing one or more streams of fuel gas mixed with water vapour into one of the first and second swirlers while introducing one or more streams of a gas or gas mixture comprising oxygen into the other one of the first and second swirlers;
downstream of the first swirler, forming a gas stream from the one or more streams of fuel gas mixed with water vapour and the one or more streams of a gas or gas mixture comprising oxygen;
downstream of the first and second swirlers, introducing the gas stream into the combustion chamber; and
in the combustion chamber, producing a flue gas stream from at least oxygen and the fuel gas mixed with water vapour.

It may be defined that swirling is provided in each one the first and second swirlers by the above-mentioned steps of introducing one or more streams. More specifically, it may be defined that, by the above-mentioned steps of introducing one or more streams into the swirlers, swirling of the fuel gas mixed with water vapour and of the gas or gas mixture comprising oxygen, or swirling of said one or more streams, is provided by, or in, the respective swirler. For some embodiments, the gas or gas mixture comprising oxygen may be air.

An advantage of the method according to the first aspect is that an improved control of the combustion in the combustion chamber is provided by the water vapour mixed with the fuel gas and introduced into one of the first and second swirlers. An advantage of the method according to the first aspect is that an improved combustion in the combustion chamber is provided, and that an improved combustion process is provided. An advantage of the method according to the first aspect is that a more reliable combustion in the combustion chamber is provided. An advantage of the method according to the first aspect is that an improved combustor unit including the combustion chamber is provided, which provides an improved combustion. An advantage of the method according to the first aspect is that the process of power generation by way of a combustor unit is improved. An advantage of the method according to the first aspect is that an improved power generation arrangement including a combustor unit is provided.

An advantage of the method according to the first aspect is that an improved flexibility of the combustion in the combustion chamber, or of the combustion system, is provided. For example, by way of the method according to the first aspect, it is easier to switch or change fuels for the combustion with a maintained sufficient reliability, or control, of the combustion. For example, by way of the method according to the first aspect, a wide range of different fuels, or fuel gases, is allowed with a maintained sufficiently reliable and stable combustion. An advantage of the method according to the first aspect is that fuel flexibility is improved, which allows for a broader spectrum of fuels to be combusted stably.

An advantage of the method according to the first aspect is that an improved reliability of the combustion in the combustion chamber, or of the combustion system, is provided. An advantage of the method according to the first aspect is that the risk of flashback from the combustion chamber and upstream is reduced, whereby operation risks are reduced. An advantage of the method according to the first aspect is that the risk of deposits, for example deposits or condensations of tar, in the combustor unit or combustion chamber is reduced. An advantage of the method according to the first aspect is that congestion may be prevented, whereby reliability is increased.

An advantage of the method according to the first aspect is high, or improved, performance in terms of combustor, or combustion chamber, pressure drop. An advantage of the method according to the first aspect is that an improved air pressure drop on the air side is provided. An advantage of the method according to the first aspect is that reduced pressure drop of the air swirler is provided, reducing the pressure drop between a compressor unit and a gas expander unit of a gas turbine unit and improving the performance of the gas turbine unit.

An advantage of the method according to the first aspect is that an improved gas turbine power generation arrangement including a combustor unit is provided.

For some embodiments, it may be defined that the gas stream formed from the one or more streams of fuel gas mixed with water vapour and the one or more streams of a gas or gas mixture comprising oxygen is formed downstream of the second swirler, or downstream of the first and second swirlers.

According to an advantageous embodiment of the method according to the first aspect, when the second swirler is arranged downstream of the first swirler the method comprises: introducing one or more streams of fuel gas mixed with water vapour into the first swirler while introducing one or more streams of a gas or gas mixture comprising oxygen into the second swirler. An advantage of this embodiment is that a further improved combustion in the combustor unit and/or in combustion chamber is provided.

According to a further advantageous embodiment of the method according to the first aspect, the method comprises:
mixing the fuel gas with the water vapour before the introduction of the one or more streams of fuel gas mixed with the water vapour into one of the first and second swirlers.

An advantage of this embodiment is that a further improved combustion in the combustor unit and/or in combustion chamber is provided. An advantage of this embodiment is that the fuel gas is efficiently diluted, whereby the maximum stoichiometric temperature of a heat release zone is reduced, which reduces emissions and increases flashback safety.

According to another advantageous embodiment of the method according to the first aspect, the method comprises:
introducing one or more streams of a gas or gas mixture comprising oxygen mixed with water vapour into one of the first and second swirlers while introducing the one or more streams of fuel gas mixed with water vapour into the other one of the first and second swirlers.

An advantage of this embodiment is that a further improved combustion in the combustor unit and/or in combustion chamber is provided by the water vapour mixed with the gas or gas mixture comprising oxygen and introduced into one of the first and second swirlers. An advantage of this embodiment is that emission control is improved. An advantage of this embodiment is that load control is improved.

According to yet another advantageous embodiment of the method according to the first aspect, the method comprises:
mixing the gas or gas mixture comprising oxygen with the water vapour before the introduction of the one or more streams of a gas or gas mixture comprising oxygen mixed with the water vapour into one of the first and second swirlers.

An advantage of this embodiment is that a further improved combustion in the combustor unit and/or in combustion chamber is provided.

According to an advantageous embodiment of the method according to the first aspect, the method comprises:
producing a stream of fuel gas in a solid or liquid fuel gasifier arranged upstream of at least one of the first and second swirlers; and
producing the one or more streams of fuel gas mixed with water vapour from water vapour and said stream of fuel gas produced in the solid or liquid fuel gasifier.

An advantage of this embodiment is that a further improved combustion in the combustor unit and/or in combustion chamber is provided.

According to a further advantageous embodiment of the method according to the first aspect, the method comprises:
treating the fuel gas of the fuel gas stream from the solid or liquid fuel gasifier in a fuel gas treatment arrangement arranged upstream of at least one of the first and second swirlers.

An advantage of this embodiment is that a further improved combustion in the combustor unit and/or in combustion chamber is provided.

According to another advantageous embodiment of the method according to the first aspect, the method comprises:
receiving the flue gas stream in a gas expander unit arranged downstream of the combustion chamber.

An advantage of this embodiment is that a further improved power generation arrangement including a gas expander unit is provided.

According to an advantageous embodiment of the method according to the first aspect, the method comprises:
introducing the one or more streams of a gas or gas mixture comprising oxygen into one of the first and second swirlers from a compressor unit.

An advantage of this embodiment is that a further improved combustion in the combustor unit and/or in combustion chamber is provided. An advantage of this embodiment is that a further improved power generation arrangement including a compressor unit is provided.

According to a further advantageous embodiment of the method according to the first aspect, the combustor unit comprises a mixing tube downstream of the first and second swirlers and upstream of the combustion chamber, wherein the method comprises receiving a gas stream in the combustion chamber, wherein the gas stream is formed from the one or more streams of fuel gas mixed with water vapour and the one or more streams of a gas or gas mixture comprising oxygen from the mixing tube. An advantage of this embodiment is that a further improved combustion in the combustor unit and/or in combustion chamber is provided.

According to a second aspect of the invention, the above mentioned and other objects are achieved with a combustor unit for the combustion of a fuel gas, wherein the combustor unit comprises
a first swirler,
a second swirler, and
a combustion chamber arranged downstream of the first and second swirlers,
wherein one of the first and second swirlers is configured to receive one or more streams of fuel gas mixed with water vapour while the other one of the first and second swirlers is configured to receive one or more streams of a gas or gas mixture comprising oxygen,
wherein the combustor unit comprises a mixing tube downstream of the first and second swirlers and upstream of the combustion chamber,
wherein the combustion chamber is configured to receive a gas stream formed from the one or more streams of fuel gas mixed with water vapour and the one or more streams of a gas or gas mixture comprising oxygen from the mixing tube, and
wherein the combustor unit is configured to produce a flue gas stream from at least oxygen and the fuel gas mixed with water vapour in the combustion chamber.

Advantages of the combustor unit according to the second aspect and its embodiments correspond to the above- or below-mentioned advantages of the method according to the first aspect and its embodiments.

According to an advantageous embodiment of the combustor unit according to the second aspect, the combustion chamber is configured to receive a gas stream formed from the one or more streams of fuel gas mixed with water vapour and the one or more streams of a gas or gas mixture comprising oxygen.

According to a further advantageous embodiment of the combustor unit according to the second aspect, the second swirler is arranged downstream of the first swirler. For alternative embodiments, the first and second swirlers may be arranged in parallel in relation to one another.

According to another advantageous embodiment of the combustor unit according to the second aspect, when the second swirler is arranged downstream of the first swirler, the first swirler is configured to receive one or more streams of fuel gas mixed with water vapour, wherein the second swirler is configured to receive one or more streams of a gas or gas mixture comprising oxygen.

According to still another advantageous embodiment of the combustor unit according to the second aspect, the combustor unit forms, or includes, a first plenum and a second plenum, wherein the first plenum is connected to the first swirler, and wherein the second plenum is connected to the second swirler. An advantage of this embodiment is that a further improved combustion in the combustor unit and/or in combustion chamber is provided.

According to an advantageous embodiment of the combustor unit according to the second aspect, the first plenum and the second plenum are separated from one another. An advantage of this embodiment is that a further improved combustion in the combustor unit and/or in combustion chamber is provided.

According to a further advantageous embodiment of the combustor unit according to the second aspect, the first plenum and the second plenum are separated from one another by one or more walls. An advantage of this embodiment is that a further improved combustion in the combustor unit and/or in combustion chamber is provided.

According to another advantageous embodiment of the combustor unit according to the second aspect, the one or more walls separating the first plenum and the second plenum from one another forms/form one or more openings for pressure equalization. An advantage of this embodiment is that a further improved combustion in the combustor unit and/or in combustion chamber is provided.

According to an advantageous embodiment of the combustor unit according to the second aspect, the first swirler is spaced apart from the second swirler.

According to a third aspect of the invention, the above mentioned and other objects are achieved with a combustor unit for the combustion of a fuel gas, wherein the combustor unit comprises
a first swirler,
a second swirler, and
a combustion chamber arranged downstream of the first and second swirlers,
wherein the combustor unit forms a first plenum and a second plenum,
wherein the first plenum is connected to the first swirler,
wherein the second plenum is connected to the second swirler,
wherein the first plenum and the second plenum are separated from one another,
wherein the combustion chamber is configured to receive one or more gas streams from the first and second swirlers, and
wherein the combustor unit is configured to produce a flue gas stream in the combustion chamber.

An advantage of the combustor unit according to the third aspect is that an improved combustion in the combustion chamber and/or in the combustor unit is provided. An advantage of the combustor unit according to the third aspect is that an improved flexibility of the combustion in the combustion chamber, or of the combustion system, is provided.

According to an advantageous embodiment of the combustor unit according to the third aspect, the first plenum and the second plenum are separated from one another by one or more walls.

According to another advantageous embodiment of the combustor unit according to the third aspect, the one or more walls separating the first plenum and the second plenum from one another forms/form one or more openings for pressure equalization.

According to yet an advantageous embodiment of the combustor unit according to the third aspect, one of the first and second swirlers is configured to receive one or more streams of fuel gas while the other one of the first and second swirlers is configured to receive one or more streams of a gas or gas mixture comprising oxygen.

According to still another advantageous embodiment of the combustor unit according to the third aspect, one of the first and second swirlers is configured to receive one or more streams of fuel gas mixed with water vapour while the other one of the first and second swirlers is configured to receive one or more streams of a gas or gas mixture comprising oxygen.

According to yet another advantageous embodiment of the combustor unit according to the third aspect, the combustor unit comprises a mixing tube downstream of the first and second swirlers and upstream of the combustion chamber, wherein the combustion chamber is configured to receive from the mixing tube a gas stream formed from the one or more gas streams from the first and second swirlers.

According to a fourth aspect of the invention, the above mentioned and other objects are achieved with a gas turbine power generation arrangement comprising
a combustor unit according to any one of the embodiments mentioned above or below, the combustor unit being configured to receive one or more fuel gas streams and produce a flue gas stream,
a gas expander unit for receiving the flue gas stream, and
a compressor unit for supplying a gas or gas mixture comprising oxygen to the combustor unit, the combustor unit being configured to receive one or more streams of a gas or gas mixture comprising oxygen from the compressor unit.

Advantages of the gas turbine power generation arrangement according to the fourth aspect and its embodiments correspond to the above- or below-mentioned advantages of the method according to the first aspect, the combustor unit according to the second aspect and their embodiments.

According to an advantageous embodiment of the gas turbine power generation arrangement according to the fourth aspect, the gas turbine power generation arrangement comprises a solid or liquid fuel gasifier for producing the one or more fuel gas streams.

According to a further advantageous embodiment of the gas turbine power generation arrangement according to the fourth aspect, the gas turbine power generation arrangement comprises a fuel gas treatment arrangement for treating the fuel gas of the fuel gas stream upstream of the combustor unit, wherein the combustor unit is configured to receive the treated fuel gas stream.

According to another advantageous embodiment of the gas turbine power generation arrangement according to the fourth aspect, the fuel gas treatment arrangement is arranged downstream of the solid or liquid fuel gasifier.

According to yet another advantageous embodiment of the gas turbine power generation arrangement according to the fourth aspect, the combustor unit is configured to receive the one or more fuel gas streams via one or more of the first and second swirlers,
wherein the compressor unit is configured to supply a gas or gas mixture comprising oxygen to the combustor unit via one or more of the first and second swirlers.

The above-mentioned features and embodiments of the method, the combustor unit and the gas turbine power generation arrangement, respectively, may be combined in various possible ways providing further advantageous embodiments.

Further advantageous embodiments of the method, the combustor unit and the gas turbine power generation arrangement according to the present invention and further advantages with the embodiments of the present invention emerge from the detailed description of embodiments.

### BRIEF DESCRIPTION OF THE DRAWINGS

Embodiments of the invention will now be illustrated, for exemplary purposes, in more detail by way of embodiments and with reference to the enclosed drawings, where similar references are used for similar parts, in which:

FIG. 1 is a schematic diagram illustrating aspects of a first embodiment of the combustor unit according to the second aspect of the invention;

FIG. 2 is a schematic diagram illustrating aspects of a second embodiment of the combustor unit according to the second aspect of the invention;

FIG. 3 is a schematic diagram illustrating aspects of a third embodiment of the combustor unit according to the second aspect of the invention;

FIG. 4 is a schematic flow chart illustrating aspects of embodiments of the method according to the first aspect of the invention;

FIG. 5 is a schematic flow chart illustrating further aspects of embodiments of the method according to the first aspect of the invention;

FIG. 6 is a schematic diagram illustrating of a first embodiment of the gas turbine power generation arrangement according to the fourth aspect of the invention;

FIG. 7 is a schematic diagram illustrating of a second embodiment of the gas turbine power generation arrangement according to the fourth aspect of the invention; and

FIG. 8 is a schematic diagram illustrating of a third embodiment of the gas turbine power generation arrangement according to the fourth aspect of the invention.

### DETAILED DESCRIPTION

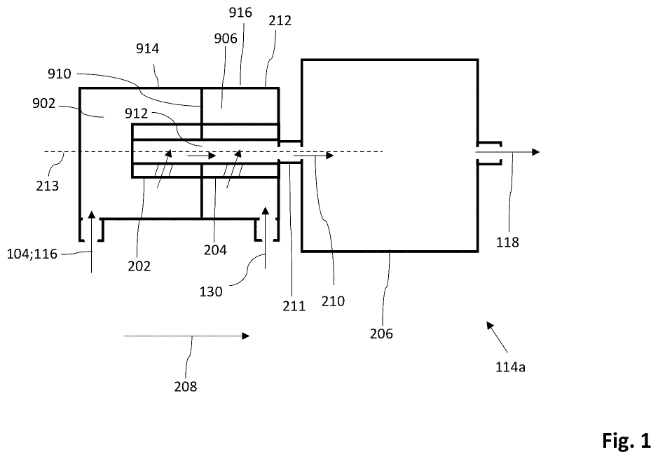

With reference to FIG. 1, a first embodiment of the combustor unit 114a for the combustion of a fuel gas, more specifically for the combustion of a fuel gas together with oxygen, according to the second aspect of the invention is schematically illustrated. The combustor unit 114a includes a first swirler 202 and a second swirler 204. Thus, the combustor unit 114a includes at least two swirlers 202, 204. For some embodiments, a swirler may be described as a device, or structure, configured to control, guide, deflect, swirl and/or mix a flow of medium entering the swirler. For example, some swirlers affect the velocity and direction of the flow of medium, and may affect the pressure, for example may provide a pressure drop. For example, a conventional swirler for a combustor may include one or more guides and/or one or more walls. The guide or wall may extend or be bent in a certain way to provide a desirable control or swirling of the flow of medium. For example, a conventional swirler may introduce an angular momentum of the medium or of the flow of medium. The guide or wall may form one or more recesses, one or more channels, one or more grooves and/or one or more openings. However, other conventional swirlers for combustors are possible. For some embodiments, the structure of the first swirler 202 may be different from the structure of the second swirler 204. For some embodiments, the first swirler 202 may be different in size in relation to the second swirler 204. For some embodiments, the structure of the first swirler 202 may be substantially equal to the structure of the second swirler 204. Different structures of a swirler for combustors are known to the person skilled in the art and are thus not disclosed in further detail herein. The fuel gas may be referred to as product gas, or syngas.

With reference to FIG. 1, the combustor unit 114a includes a combustion chamber 206 arranged downstream of the first and second swirlers 202, 204. One 202 of the first and second swirlers 202, 204 is configured to receive one or more streams 104; 116 of fuel gas mixed with water vapour while the other one 204 of the first and second swirlers 202, 204 is configured to receive one or more streams 130 of a gas or gas mixture comprising, or consisting of, oxygen. For some embodiments, the gas or gas mixture comprising oxygen may comprise or consist of air. It is to be understood that air includes oxygen. However, other gases or gas mixtures, which comprise oxygen, are possible. The combustor unit 114a is configured to produce a flue gas stream 118 in the combustion chamber 206 from at least oxygen and the fuel gas mixed with water vapour. The water vapour may be called steam. The flue gas may be referred to as exhaust gas, or combustion exhaust gas.

With reference to FIG. 1, for some embodiments, the second swirler 204 is arranged downstream of the first swirler 202, for example in a flow direction 208, or an axial, or downstream, direction. Thus, for some embodiments, the swirled stream or flow from the first swirler 202 may downstream be mixed with the swirled stream or flow of the second swirler 204. In the embodiment illustrated in FIG. 1, when the second swirler 204 is arranged downstream of the first swirler 202, the first swirler 202 may be configured to receive the stream 104; 116 of fuel gas mixed with water vapour while the second swirler 204 may be configured to receive the stream 130 of a gas or gas mixture comprising oxygen, for example air. For alternative embodiments, the second swirler 204 may be configured to receive two or more streams 130 of a gas or gas mixture comprising oxygen. By introducing the gas or gas mixture comprising oxygen downstream of the introduction of fuel gas mixed with water vapour as disclosed above, and/or by keeping the fuel gas mixed with water vapour separated from the gas or gas mixture comprising oxygen as long as possible, an improved control of the combustion in the combustion chamber is provided and/or the risk of flashback is reduced. Further, it is easier to switch or change fuels for the combustion with a maintained sufficient control of the combustion, for example a switch to a fuel gas having a high level of H₂, such as close to 100% H₂. Thus, an enhanced fuel gas flexibility is provided. For alternative embodiments, the above- or below-mentioned streams may enter the respective swirler 202, 204 according to other directions.

With reference to FIG. 1, for some embodiments, it may be defined that the combustion chamber 206 is configured to receive a gas stream 210 formed from the stream 104; 116 of fuel gas mixed with water vapour and the stream 130 of a gas or gas mixture comprising oxygen. The gas stream 210 may be described as a swirled, or swirling, gas stream or mixture. For embodiments, the combustor unit 114a includes a mixing tube 211, for example downstream of the first and second swirlers 202, 204, and for example upstream of the combustion chamber 206. The gas stream 210 formed from the stream 104; 116 of fuel gas mixed with water vapour and the stream 130 of a gas or gas mixture comprising oxygen may, at least partially, be formed in the mixing tube 211. For embodiments, the combustion chamber 206 is configured to receive a gas stream 210 formed from the one or more streams 104; 116 of fuel gas mixed with water vapour and the one or more streams 130 of a gas or gas mixture comprising oxygen from the mixing tube 211.

With reference to FIG. 1, for some embodiments, the first swirler 202 may be spaced apart from the second swirler 204, for example in the flow direction 208, or an axial direction, or an upstream or downstream direction. For some embodiments, the first swirler 202 and the second swirler 204 may be separated from one another. The first and second swirlers 202, 204 may be described to be fluidly connected to one another. For some embodiments, the combustor unit 114a may comprise a casing 212 housing the first and second swirlers 202, 204. For some embodiments, the casing 212 may also house the combustion chamber 206.

With reference to FIG. 1, for some embodiments, one or more of the streams 104, 116, 130 may enter the first or second swirler 202, 204 in a radial direction, or a substantially radial direction, in relation to a central axis 213 of the first and/or second swirler 202, 204. The central axis 213 may extend in the flow direction 208 or the downstream direction. For alternative embodiments, one or more of the streams 104, 116, 130 may enter the first or second swirler 202, 204 in a longitudinal or axial direction, or a substantially axial direction, in parallel to or in line with the central axis 213 of the first and/or second swirler 202, 204. For some embodiments, any combination of radial and axial directions of the entries of the streams 104, 116, 130 may be applied.

With reference to FIG. 1, also embodiments of the combustor unit 114a for the combustion of a fuel gas according to the third aspect of the invention and according to embodiments of the second aspect of the invention are schematically illustrated. As already stated above, the combustor unit 114a includes a first swirler 202 and a second swirler 204, and the combustor unit 114a includes a combustion chamber 206 arranged downstream of the first and second swirlers 202, 204. The combustor unit 114a forms, or includes, a first plenum 902 and a second plenum 906. The first plenum 902 is connected, for example fluidly connected, to the first swirler 202. The second plenum 906 is connected, for example fluidly connected, to the second swirler 204. For some embodiments, it may be defined that the first plenum 902 is associated with the first swirler 202 while the second plenum 906 is associated with the second swirler 204.

With reference to FIG. 1, the combustion chamber 206 is configured to receive one or more gas streams 210 from the first and second swirlers 202, 204. The combustion chamber 206 may be configured to receive one or more gas streams 210 directly or indirectly from the first swirler 202 or the second swirler 204, for example indirectly via the other one 202, 204 of the first and second swirlers 202, 204. The combustor unit 114a is configured to produce a flue gas stream 118 in the combustion chamber 206, for example from the one or more gas streams 210 received from the first and second swirlers 202, 204. For some embodiments, and as already stated above, the combustor unit 114a may include a mixing tube 211, for example downstream of the first and second swirlers 202, 204, and for example upstream of the combustion chamber 206. The gas stream 210 formed from the stream 104; 116 of fuel gas mixed with water vapour and the stream 130 of a gas or gas mixture comprising oxygen may, at least partially, be formed in the mixing tube 211. The combustion chamber 206 may be configured to receive a gas stream 210 formed from the one or more streams 104; 116 of fuel gas mixed with water vapour and the one or more streams 130 of a gas or gas mixture comprising oxygen from the mixing tube 211.

With reference to FIG. 1, for some embodiments, the plenum 902, 906 may be referred to as a space, or room, which may be described to be filled with a gas or gas-mixture. For some embodiments, one or more of the first plenum 902 and second plenum 906 may be annular. For some embodiments, the casing 212 of the combustor unit 114a may enclose, or define, the first plenum 902 and/or the second plenum 906. For some embodiments, the first plenum 902 may surround the first swirler 202. For some embodiments, the second plenum 906 may surround the second swirler 204.

With reference to FIG. 1, for embodiments, the first plenum 902 and the second plenum 906 are separated from one another, for example by one or more walls 910. The one or more walls 910 separating the first plenum 902 and the second plenum 906 from one another may form one or more openings 912 for pressure equalization. For some embodiments, the combustor unit 114a may include a first plenum casing 914, which, for example, may enclose, or define, the first plenum 902. The first plenum casing 914 may house the first swirler 202. For some embodiments, the combustor unit 114a may include a second plenum casing 916, which, for example, may enclose, or define, the second plenum 906. The second plenum casing 916 may house the second swirler 204.

With reference to FIG. 1, for some embodiments, one 202, 204 of the first and second swirlers 202, 204 is configured to receive one or more streams 104; 116 of fuel gas while the other one 202, 204 of the first and second swirlers 202, 204 is configured to receive one or more streams 130 of a gas or gas mixture comprising oxygen. For some embodiments, one 202, 204 of the first and second swirlers 202, 204 is configured to receive one or more streams 104; 116 of fuel gas mixed with water vapour while the other one 202, 204 of the first and second swirlers 202, 204 is configured to receive one or more streams 130 of a gas or gas mixture comprising oxygen. For example, for some embodiments, the first swirler 202 may be configured to receive one or more streams 104; 116 of fuel gas mixed with water vapour while the second swirler 204 may be configured to receive one or more streams 130 of a gas or gas mixture comprising oxygen. However, for other embodiments, it may be the other way around.

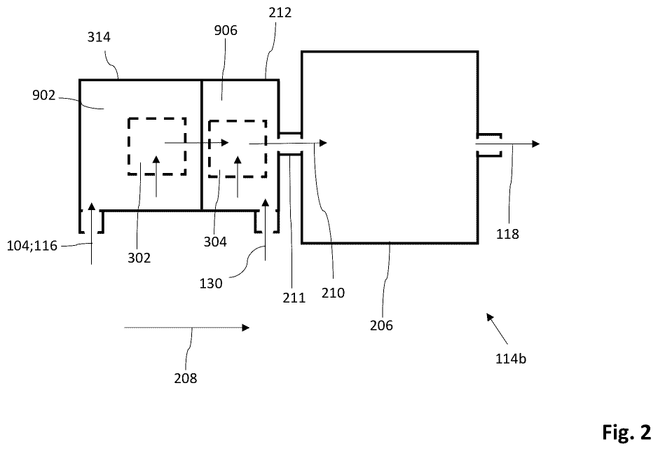

With reference to FIG. 2, a second embodiment of the combustor unit 114b according to the second aspect of the invention is schematically illustrated. Several features of the combustor unit 114b of FIG. 2 may correspond to features of the combustor unit 114a of FIG. 1 and are thus not described in further detail here to avoid repetition. The combustor unit 114b of FIG. 2 differs from the combustor unit 114a of FIG. 1 in that the first swirler 302 is in the form of, or comprises, a first swirler section 302, or a first swirler region/zone, and in that the second swirler 304 is in the form of, or comprises, a second swirler section 304, or a second swirler region/zone. For some embodiments, the first and second swirler sections 302, 304 may be housed in a housing 314 included in the combustor unit 114b. For some embodiments, the casing 212 may house the housing 314. However, for some embodiments, the housing 314 may be excluded. Otherwise, the combustor unit 114b of FIG. 2 may be configured in a corresponding manner as the combustor unit 114a of FIG. 1. For some embodiments, the first swirler section 302 and the second swirler section 304 may at least partially, or completely, overlap. For alternative embodiments, the first swirler section 302 and the second swirler section 304 may be arranged least partially, or completely, in parallel in relation to one another.

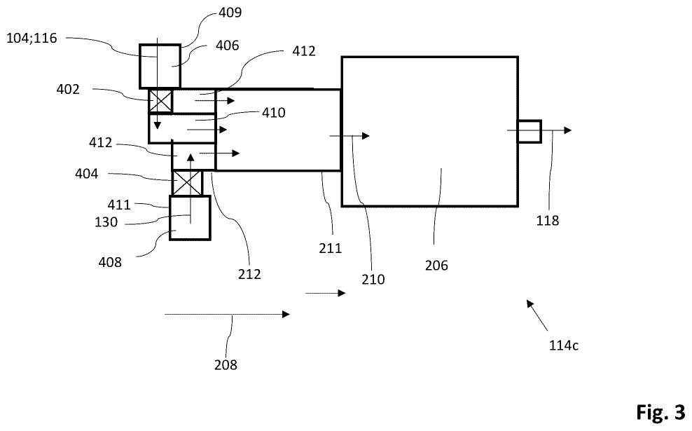

With reference to FIG. 3, a third embodiment of the combustor unit 114c according to the second aspect of the invention is schematically illustrated. Several features of the combustor unit 114c of FIG. 3 may correspond to features of the combustor unit 114a of FIG. 1 and are thus not described in further detail here to avoid repetition. The combustor unit 114c of FIG. 3 differs from the combustor unit 114a of FIG. 1 in that the second swirler 404 of the combustor unit 114c is not arranged downstream of the first swirler 402 of the combustor unit 114c. The combustor unit 114c may form, or may include, a first plenum 406 and a second plenum 408. The first plenum 406 is connected, for example fluidly connected, to the first swirler 402. The second plenum 408 is connected, for example fluidly connected, to the second swirler 404. The first plenum 406 may be upstream of the first swirler 402. The second plenum 408 may be upstream of the second swirler 404. For some embodiments, the combustor unit 114c may include a first plenum casing 409, which, for example, may enclose, or define, the first plenum 906. For some embodiments, the combustor unit 114c may include a second plenum casing 411, which, for example, may enclose, or define, the second plenum 408.

With reference to FIG. 3, for some embodiments, the one or more streams 104; 116 from the first swirler 402 may enter an inner annulus, or an inner annular space 410. For some embodiments, the one or more streams 130 from the second swirler 404 may enter an outer annulus, or an outer annular space 412, for example surrounding the inner annular space 410. The streams from the inner and outer annular spaces 410, 412 may then enter the mixing tube 211, and thereafter the combustion chamber 206. Otherwise, the combustor unit 114c of FIG. 3 may be configured in a corresponding manner as any one of the combustor units 114a and 114b of FIGS. 1 and 2.

With reference to FIGS. 1 to 3, for some embodiments, one or more additional swirlers may added and arranged downstream of the first and second swirlers 202, 302, 402, 204, 304, 404 (or upstream of the first and second swirlers 202, 302, 402, 204, 304, 404) and upstream of the combustion chamber 206. For some embodiments, the one or more additional swirlers may be configured to introduce additional gas or gas mixture comprising oxygen, air, and/or fuel gas, for example mixed with water vapour, for example in one or more swirled flows, whereby staged combustion may be provided. For some embodiments, the one or more additional swirlers may introduce substantially pure water vapour. For some embodiments, the one or more additional swirlers may introduce a fuel gas different from the fuel gas introduced via the first and second swirlers 202, 302, 402, 204, 304, 404. Different swirler intensities may be applied in, or to, various stages of the combustor unit 114a-c. Various combinations of said one or more additional swirlers are possible.

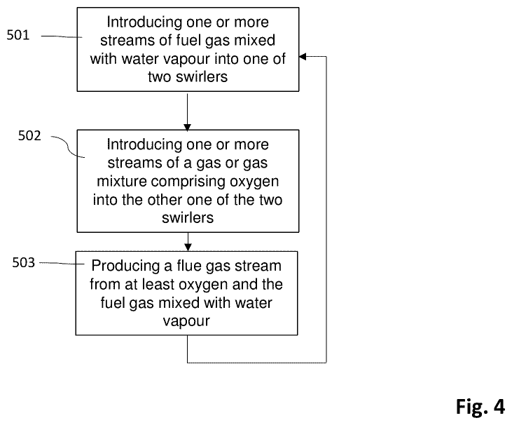

With reference to FIG. 4, aspects of embodiments of the method for the combustion of a fuel gas in a combustor unit 114a-c are schematically illustrated in a flow chart, wherein the combustor unit 114a-c includes a first swirler 202, 302, 402, a second swirler 204, 304, 404, which is arranged downstream of the first swirler 202, 302, 402, and a combustion chamber 206 arranged downstream of the first and second swirlers 202, 302, 402, 204, 304, 404. Embodiments of the method include the steps of:
introducing 501 one or more streams 104; 116 of fuel gas mixed with water vapour into one 202, 302, 402, 204, 304, 404 of the first and second swirlers 202, 302, 402, 204, 304, 404 while introducing 502 one or more streams 130 of a gas or gas mixture comprising, or consisting of, oxygen into the other one 202, 302, 402, 204, 304, 404 of the first and second swirlers 202, 302, 402, 204, 304, 404; and.
in the combustion chamber 206, producing 503 a flue gas stream 118 from at least oxygen and the fuel gas mixed with water vapour.

With reference to FIG. 4, for some embodiments, the gas or gas mixture comprising oxygen may comprise or consist of air. However, other gases or gas mixtures, which comprise oxygen, are possible.

With reference to FIG. 4, step 501 and step 502 may be performed simultaneously, or substantially at the same time. For some embodiments, step 502 may be performed before step 501. By the steps of introduction 501, 502 of one or more streams mentioned above, it may be described that swirling is provided, or attained, in each one 202, 302, 402, 204, 304, 404 of the first and second swirlers 202, 302, 402, 204, 304, 404, more specifically, swirling of the fuel gas mixed with water vapour and swirling of the gas or gas mixture comprising oxygen, and/or swirling of the streams.

With reference to FIG. 4, for alternative embodiments of the method, the first swirler 402 and the second swirler 404 may be arranged in parallel in relation to one another.

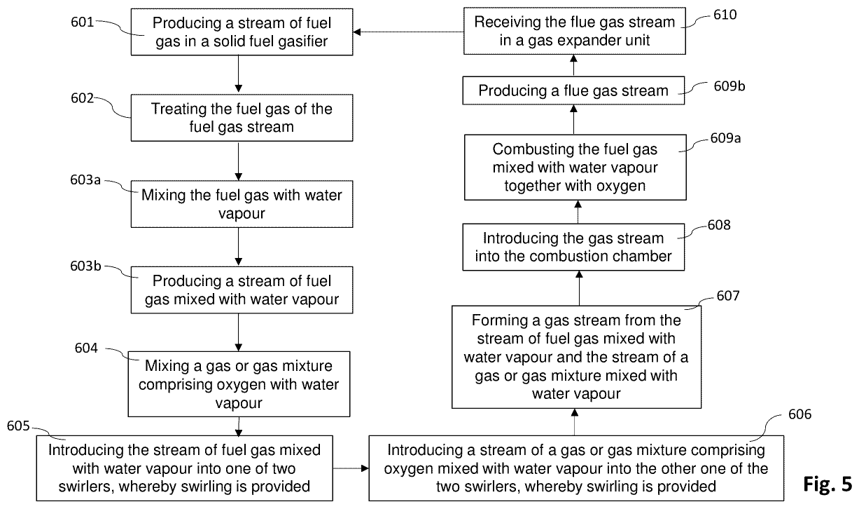

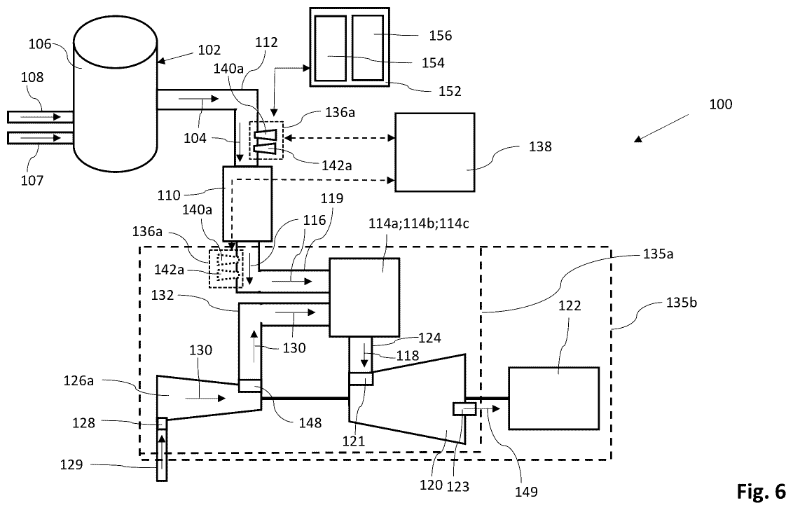

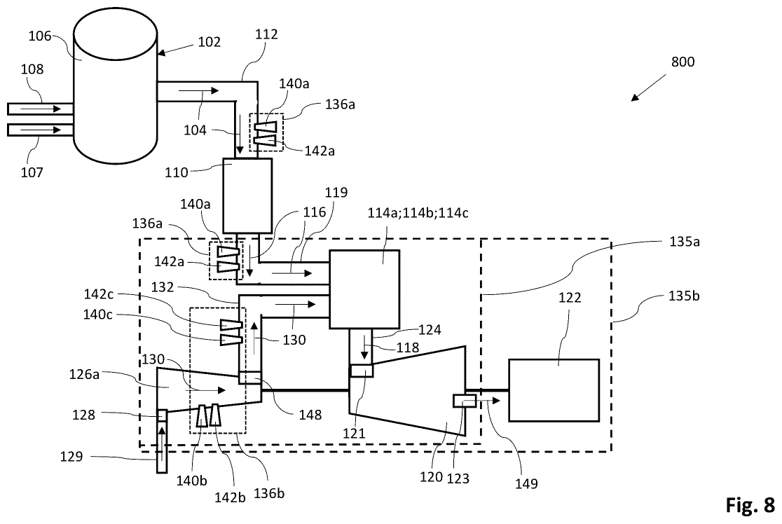

With reference to FIG. 5, further aspects of embodiments of the method for the combustion of a fuel gas in a combustor unit 114a-c are schematically illustrated in a flow chart. Embodiments of the method may include one or more steps, for example three, four or five steps, of the steps of:
producing 601 a stream 104 of fuel gas, for example from a solid or liquid fuel (for example of any one of the sorts mentioned below in connection with FIG. 6), in a solid or liquid fuel gasifier 102 (see FIGS. 6 to 8) arranged upstream of at least one 202, 302, 402, 204, 304, 404 of the first and second swirlers 202, 302, 402, 204, 304, 404, for example upstream of both of the first and second swirlers 202, 302, 402, 204, 304, 404;
treating 602 the fuel gas of the fuel gas stream 104 from the solid or liquid fuel gasifier 102 in a fuel gas treatment arrangement 110 (see FIGS. 6 and 8) arranged upstream of at least one 202, 302, 402, 204, 304, 404 of the first and second swirlers 202, 302, 402, 204, 304, 404, for example upstream of both of the first and second swirlers 202, 302, 402, 204, 304, 404;
before the introduction 605 of a stream 104; 116 of fuel gas mixed with water vapour into one 202, 302, 402, 204, 304, 404 of the first and second swirlers 202, 302, 402, 204, 304, 404, mixing 603a the fuel gas with water vapour and thus producing 603b the stream 104; 116 of fuel gas mixed with water vapour from water vapour and said stream of fuel gas produced in the solid or liquid fuel gasifier 102;
before the introduction 606 of a stream 130 of a gas or gas mixture comprising oxygen mixed with the water vapour into one 202, 302, 402, 204, 304, 404 of the first and second swirlers 202, 302, 402, 204, 304, 404, mixing 604 the gas or gas mixture comprising oxygen with water vapour;
introducing 605 the stream 104; 116 of fuel gas mixed with water vapour into one 202, 302, 402, 204, 304, 404 of the first and second swirlers 202, 302, 402, 204, 304, 404, whereby the stream 104; 116 of fuel gas mixed with water vapour is swirled in the swirler in question, and a swirling stream of fuel gas is provided, while.
introducing 606 the stream 130 of a gas or gas mixture comprising oxygen, which includes oxygen, mixed with water vapour into the other one 202, 302, 402, 204, 304, 404 of the first and second swirlers 202, 302, 402, 204, 304, 404 from a compressor unit 126a, which for some embodiments may have an gas inlet 128, whereby the stream 130 of a gas or gas mixture comprising oxygen mixed with water vapour is swirled in the swirler in question, and a swirling stream of a gas or gas mixture comprising oxygen mixed with water vapour is provided;
downstream of one 202, 302, 402, 204, 304, 404 of the first and second swirlers 202, 302, 402, 204, 304, 404, such as downstream of the first or second swirler 202, 204 or of both swirlers 202, 204, forming 607 a gas stream 210, which may be a swirling gas stream, from the stream 104; 116 of fuel gas mixed with water vapour and the stream 130 of a gas or gas mixture comprising oxygen mixed with water vapour;
downstream of the first and second swirlers 202, 302, 402, 204, 304, 404, introducing 608 the gas stream 210 into the combustion chamber 206;
in the combustion chamber 206, combusting 609a the fuel gas mixed with water vapour together with oxygen and thus producing 609b a flue gas stream 118 from at least oxygen and the fuel gas mixed with water vapour; and.
receiving 610 the flue gas stream 118 in a gas expander unit 120 (see FIGS. 6 to 8) arranged downstream of the combustion chamber 206. For some embodiments, the gas expander unit 120 may be configured to be mechanically coupled to an electric generator 122 (see FIGS. 6 to 8). For other embodiments, the gas expander unit 120 may be configured to be mechanically coupled to any other type of mechanical load, for example a compressor, or a propeller.

With reference to FIG. 5, step 605 and step 606 may be performed simultaneously, or substantially at the same time. For some embodiments, step 606 may be performed before step 605. For some embodiments, the stream 104; 116 of fuel gas mixed with water vapour and the stream 130 of a gas or gas mixture comprising oxygen may be introduced into the combustion chamber 206 without forming said gas stream 210 in step 607. Thus, for some embodiments, steps 607 and 608 may be excluded, and some embodiments may instead include the step of introducing the stream 104; 116 of fuel gas mixed with water vapour into the combustion chamber 206 and the step of introducing the stream 130 of a gas or gas mixture comprising oxygen into the combustion chamber 206, for example downstream of one or more of the first and second swirlers 202, 302, 402, 204, 304, 404.

Unless disclosed otherwise, it should be noted that the method steps illustrated in FIGS. 4 and 5 and described herein do not necessarily have to be executed in the order illustrated in FIGS. 4 and 5. The steps may essentially be executed in any suitable order. Further, one or more steps may be added without departing from the scope of the appended claims. One or more steps may be excluded from an embodiment of the method without departing from the scope of the appended claims.

With reference to FIG. 5, for some embodiments, it may be defined that the step of producing 503; 609a a flue gas stream 118 from at least oxygen and the fuel gas mixed with water vapour includes producing a flue gas stream 118 from at least oxygen of the gas stream 210 and from the fuel gas mixed with water vapour of the gas stream 210. Since the gas stream 210 is formed from the one or more streams 104; 116 of fuel gas mixed with water vapour from one of the swirlers 202, 204 and the one or more streams 130 of a gas or gas mixture comprising oxygen from the other one 202, 204 of the swirlers 202, 204, this in general implies that no oxygen or air is introduced into the swirler 202, 204 which receives the one or more streams 104; 116 of fuel gas mixed with water vapour, and that no fuel gas (or fuel) is introduced into the swirler 202, 204 which receives the one or more streams 130 of a gas or gas mixture comprising oxygen.

With reference to FIG. 5, for some embodiments, it may be defined that the step of introducing 501; 605 one or more streams 104; 116 of fuel gas mixed with water vapour into one 202, 204; 302, 304; 402, 404 of the first and second swirlers 202, 204; 302, 304; 402, 404 includes introducing 501; 605 one or more streams 104; 116 of fuel gas mixed with water vapour without any gas or gas mixture comprising oxygen into one 202, 204; 302, 304; 402, 404 of the first and second swirlers 202, 204; 302, 304; 402, 404. Additionally, or for some embodiments, it may be defined that the step of introducing 502; 606 one or more streams 130 of a gas or gas mixture comprising oxygen into the other one 202, 204; 302, 304; 402, 404 of the first and second swirlers 202, 204; 302, 304; 402, 404 includes introducing 502; 606 one or more streams 130 of a gas or gas mixture comprising oxygen without any fuel gas (or fuel) into the other one 202, 204; 302, 304; 402, 404 of the first and second swirlers 202, 204; 302, 304; 402, 404. For some embodiments, the step of forming 607 a gas stream 210 from the one or more streams 104; 116 of fuel gas mixed with water vapour and the one or more streams 130 of a gas or gas mixture comprising oxygen may include: in a mixing tube 211 forming 607 a gas stream 210 from the one or more streams 104; 116 of fuel gas mixed with water vapour and the one or more streams 130 of a gas or gas mixture comprising oxygen.

With reference to FIG. 6, a first embodiment of the gas turbine power generation arrangement 100 according to the fourth aspect of the invention is schematically illustrated. For some embodiments, the gas turbine power generation arrangement may be a gas turbine power generation plant. For some embodiments, the gas turbine power generation arrangement 100 may include a solid or liquid fuel gasifier 102 for producing a fuel gas stream 104, 116. The solid or liquid fuel may be a solid or liquid carbon fuel, for example biomass, peat, wood, energy crop, wastes, coal etc., or any mixture thereof. However, other solid or liquid fuels are possible. It may be described that a gasification of the solid or liquid fuel is performed in the solid or liquid fuel gasifier 102. For some embodiments, the solid or liquid fuel gasifier 102 may be referred to as a fluidized bed gasifier 102. For some embodiments, the solid or liquid fuel gasifier 102 may be called a reactor. The solid or liquid fuel gasifier 102 may include a vessel 106. For some embodiments, the vessel 106 may have a tubular shape, for example a circular tubular shape, but other shapes or possible. The vessel 106 may be made of a suitable metal material, or any other suitable material. The vessel 106 may comprise one or more refractory and/or insulation layers, which for example may be located inside of a tubular metal wall of the vessel 106. The solid or liquid fuel gasifier 102, or the vessel 106, may be described to contain a turbulent fluidized bed. The turbulent fluidized bed may be referred to as a bubbling fluidized bed. The turbulent fluidized bed may comprise a solid or liquid fuel and solid or liquid fuel particles to which a gasification medium, for example including one or more of: H₂O, air, O₂, N₂ and steam, is added. The solid or liquid fuel particles may be solid carbon fuel particles. For some embodiments, the solid or liquid fuel gasifier 102 is pressurised to about 60 to 70 bar. For some embodiments, the temperature of the fuel gas stream 104 leaving the solid or liquid fuel gasifier 102 may be at least 1000 degrees Celsius.

With reference to FIG. 6, the turbine power generation arrangement 100 may include a solid or liquid fuel, or raw fuel, inlet conduit 107. The solid or liquid fuel gasifier 102 may be configured to receive solid or liquid fuel via the solid or liquid fuel inlet conduit 107. The turbine power generation arrangement 100 may include a gasification medium inlet conduit 108. The solid or liquid fuel gasifier 102 may be configured to receive the gasification medium via the gasification medium inlet conduit 108.

With reference to FIG. 6, for some embodiments, the gas turbine power generation arrangement 100 may include a fuel gas treatment arrangement 110 for treating the fuel gas of the fuel gas stream 104 from the solid or liquid fuel gasifier 102. The fuel gas treatment arrangement 110 may be connected to the solid or liquid fuel gasifier 102 via a conduit 112. When an item is disclosed to be connected to another item in this disclosure, in general it implies that the two items are fluidly connected to one another. It may be defined that the fuel gas treatment arrangement 110 is arranged downstream of the solid or liquid fuel gasifier 102. For some embodiments, the fuel gas treatment arrangement 110 may include a fuel gas clean-up device, wherein, inter alia, unwanted impurities are removed from the fuel gas stream 104. For example, for some embodiments, the fuel gas treatment arrangement 110 may include one or more filters or filtering steps. However, it is to be understood that the fuel gas treatment arrangement 110 may include other or additional fuel gas treatment equipment or units. For some embodiments, the fuel gas treatment arrangement 110 may be excluded.

With reference to FIG. 6, the gas turbine power generation arrangement 100 includes a combustor unit 114a-c, for example according to any one of the embodiments of the combustor units 114a; 114b; 114c disclosed above in connection with FIGS. 1 to 3 and/or according to any one of the embodiments disclosed below. In the embodiment disclosed in FIG. 6, the combustor unit 114a-c is configured to receive a fuel gas stream 104, 116 and configured to produce a flue gas stream 118. For some embodiments, the combustor unit 114a-c may be configured to receive a treated fuel gas stream 116 from the fuel gas treatment arrangement 110 and configured to produce a flue gas stream 118. For some embodiments, it may be defined that the combustor unit 114a-c is configured to combust fuel gas of the fuel gas stream 104 or of treated fuel gas stream 116. Thus, fuel gas of the fuel gas stream 104 or of the treated fuel gas stream 116 is combusted in the combustor unit 114a-c, for example together with oxygen supplied by a compressor unit 126a disclosed below. The combustor unit 114a-c may be connected to the fuel gas treatment arrangement 110 via a conduit 119. It may be defined that the combustor unit 114a-c is arranged downstream of the fuel gas treatment arrangement 110. It may be defined that the combustor unit 114a-c is arranged downstream of the solid or liquid fuel gasifier 102. The flue gas of the flue gas stream 118 exiting the combustor unit 114a-c may have 5-10% volume water vapour. However, other % volumes are possible. For some embodiments, the fuel gas treatment arrangement 110 may be described to be configured to treat the fuel gas of the fuel gas stream 104 from the solid or liquid fuel gasifier 102 upstream of the combustor unit 114a-c.

With reference to FIG. 6, the gas turbine power generation arrangement 100 includes a gas expander unit 120 for receiving the flue gas stream 118. For some embodiments, the gas expander unit 120 may be referred to as a gas expander. For some embodiments, the gas expander unit 120 may be configured to be mechanically coupled to an electric generator 122. The electric generator 122 may be described to generate, or produce, electric power or energy, or convert motive power into electric power. It may be defined that the electric generator 122 is configured to generate electric power from mechanical movement, or mechanical energy, of the gas expander unit 120. For some embodiments, the gas expander unit 120 may be connected to the combustor unit 114a-c via a conduit 124. It may be defined that the gas expander unit 120 is arranged downstream of the combustor unit 114a-c. For some embodiments, it may be defined that the gas expander unit 120 is arranged downstream of the fuel gas treatment arrangement 110. For some embodiments, it may be defined that the gas expander unit 120 is arranged downstream of the solid or liquid fuel gasifier 102. It may be defined that the gas expander unit 120 is configured to receive the flue gas stream 118. It may be defined that the gas expander unit 120 comprises an inlet 121 for the flue gas stream 118, or an inlet 121 for receiving the flue gas stream 118. It may be defined that the gas expander unit 120 comprises an outlet 123.

With reference to FIG. 6, it may be defined that the electric generator 122 includes a stator and a rotor rotatable about an axis of rotation in relation to the stator. The gas expander unit 120 may be described to comprise a rotatable member rotatable by the output of the combustor 114a-c. For some embodiments, the rotatable member of the gas expander unit 120 may be described to be configured to rotate the rotor of the electric generator 122.

With reference to FIG. 6, the gas turbine power generation arrangement 100 includes a compressor unit 126a for supplying a gas or gas mixture comprising oxygen to the combustor unit 114a-c, for example air. For some embodiments, the compressor unit 126a may include a gas inlet 128 for the inlet of a gas or gas mixture comprising oxygen. For some embodiments, the compressor unit 126a may include an air inlet 128 for the inlet of air. The turbine power generation arrangement 100 may include a gas inlet conduit 129 connected to the gas inlet 128. It may be defined that the gas inlet 128 is located downstream of the inlet conduit 129. The compressor unit 126a may be configured to receive a gas or gas mixture comprising oxygen via the gas inlet 128 and/or the gas inlet conduit 129. The combustor unit 114a-c illustrated in FIG. 6 is configured to receive a stream 130 of a gas or gas mixture comprising oxygen from the compressor unit 126a. For some embodiments, the compressor unit 126a may be referred to as a compressor. For some embodiments, the combustor unit 114a-c may be connected to the compressor unit 126a via a conduit 132. It may be defined that the combustor unit 114a-c is arranged downstream of the compressor unit 126a. For some embodiments, the gas expander unit 120 may be mechanically coupled to the compressor unit 126a, for example to transfer motive power to the compressor unit 126a. The compressor unit 126a may be defined to be configured for the compression of a gas or gas mixture comprising oxygen, for example air. The compressor unit 126a may be described to comprise a rotatable member. The rotatable member of the gas expander unit 120 may be described to be configured to rotate the rotatable member of the compressor unit 126a, for example to compress the gas or gas mixture comprising oxygen.

With reference to FIGS. 1 to 3 and 6, the combustor unit 114a-c may be described to be configured to receive the fuel gas stream 104; 116, or the stream 104; 116 of fuel gas, via one or more of the first and second swirlers 202, 302, 402, 204, 304, 404. The compressor unit 126a may be described to be configured to supply a gas or gas mixture comprising oxygen, for example air, to the combustor unit 114a-c via one or more of the first and second swirlers 202, 302, 402, 204, 304, 404.

With reference to FIG. 6, for some embodiments, the turbine power generation arrangement 100 may be described to comprise a gas turbine unit 135a, 135b. The gas turbine unit 135a, 135b may comprise the combustor unit 114a-c, the gas expander unit 120 and the compressor unit 126a. In addition, for some embodiments, the gas turbine unit 135b may be described to comprise the electric generator 122. Thus, it may be described that the gas expander unit 120 is included in, or part of, a gas turbine unit 135a, 135b.

With reference to FIG. 6, it is to be understood that various features or items of the turbine power generation arrangement 100 in FIG. 6 may be arranged in various ways, for example different from what is schematically illustrated in FIG. 6. For example, for some embodiments, one or more features or items illustrated in FIG. 6 may be excluded, for example one or more of the conduits as illustrated may be excluded. For some embodiments, one or more additional items may be added.

With reference to FIG. 6, for some embodiments, the gas turbine power generation arrangement 100 may include one or more water fluid injector units 136a; 136b for injecting water fluid into the fuel gas stream 104, 116 upstream of the combustor unit 114a-c. For some embodiments, the one or more water fluid injector units 136a is/are configured to inject water fluid into the stream 130 of a gas or gas mixture comprising oxygen from the compressor unit 126a upstream of the combustor unit 114a-c. For some embodiments, the one or more water fluid injector units 136a is/are configured to inject water fluid into the fuel gas stream 104 upstream of the fuel gas treatment arrangement 110 and/or into the fuel gas stream 116 downstream of the fuel gas treatment arrangement 110. For some embodiments, the one or more water fluid injector units 136a is/are configured to inject water fluid into both the stream 130 of a gas or gas mixture comprising oxygen upstream of the combustor unit 114a-c and the fuel gas stream 104, 116 upstream of the combustor unit 114a-c. For some embodiments, each water fluid injector unit 136a may comprise one or more water fluid injectors for injecting water fluid. For some embodiments, water fluid injectors of the same water fluid injector unit 136a may be spaced apart.

Water fluid may comprise or consist of one or more of the group of: water liquid; and water vapour or steam. The water liquid is water in liquid form and may also be called liquefied water or simply water. The water vapour may be called steam. The water liquid or water may be hot when injected. In general, a fluid may comprise or consist of one or more of the group of: a liquid; a gas, such as steam; a gas mixture; and a mixture of a liquid and one or more gases.

With reference to FIG. 6, for some embodiments, the gas turbine power generation arrangement 100 may include a control arrangement 138 for controlling the rate of the water fluid injection of the one or more water fluid injector units 136a.

More specifically, in the embodiment illustrated in FIG. 6, the one or more water fluid injector units 136a may include a first water fluid injector unit 136a for injecting water fluid into the fuel gas stream 104, 116 downstream of the solid or liquid fuel gasifier 102 and upstream of the combustor unit 114a-c. Even more specifically, in the embodiment illustrated in FIG. 6, the first water fluid injector unit 136a is configured to inject water fluid into the fuel gas stream 104 upstream of the fuel gas treatment arrangement 110.

With reference to FIG. 6, the first water fluid injector unit 136a may include one or more of the group of:
a first water liquid injector 140a for injecting water liquid into the fuel gas stream 104, 116 downstream of the solid or liquid fuel gasifier 102 and upstream of the combustor unit 114a-c; and
a first water vapour, or steam, injector 142a for injecting water vapour into the fuel gas stream 104, 116 downstream of the solid or liquid fuel gasifier 102 and upstream of the combustor unit 114a-c.

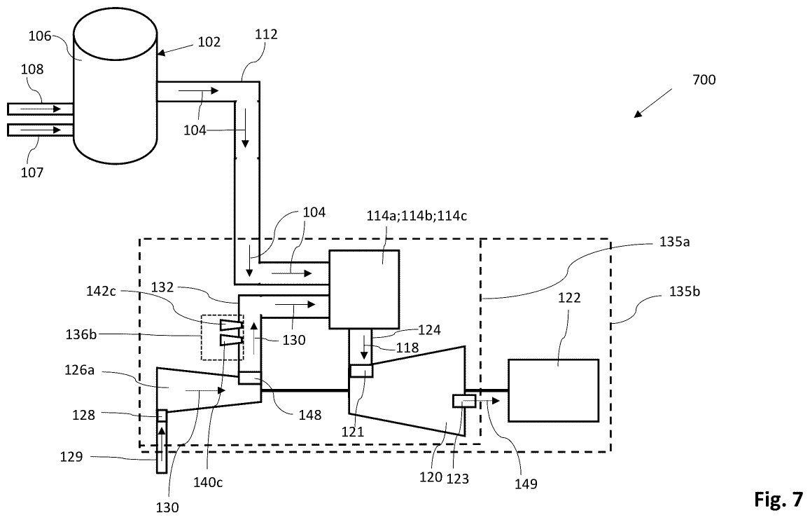

With reference to FIG. 7, a second embodiment of the gas turbine power generation arrangement 700 according to the fourth aspect of the invention is schematically illustrated. Several features of the gas turbine power generation arrangement 700 of FIG. 7 may correspond to features of the gas turbine power generation arrangement 100 of FIG. 6 and are thus not described in further detail here to avoid repetition. In the embodiment of FIG. 7, the fuel gas treatment arrangement 110 illustrated in FIG. 6 has been excluded. For some embodiments, the one or more water fluid injector units 136a; 136b may include a second water fluid injector unit 136b configured to inject water fluid into the stream 130 of a gas or gas mixture comprising oxygen downstream of the compressor unit 126a and upstream of the combustor unit 114a-c. For some embodiments, it may be defined that the second water fluid injector unit 136b is configured to inject water fluid into the stream 130 of a gas or gas mixture comprising oxygen downstream of a gas outlet 148 of the compressor unit 126a and upstream of the combustor unit 114a-c.

With reference to FIG. 7, for some embodiments, the second water fluid injector unit 136b may include one or more of the group of:
a third water liquid injector 140c for injecting water liquid into the stream 130 of a gas or gas mixture comprising oxygen downstream of the compressor unit 126a and upstream of the combustor unit 114a-c; and
a third water vapour, or steam, injector 142c for injecting water vapour into the stream 130 of a gas or gas mixture comprising oxygen downstream of the compressor unit 126a and upstream of the combustor unit 114a-c.

With reference to FIG. 7, it is to be understood that various features or items of the turbine power generation arrangement 700 in FIG. 7 may be arranged in various ways, for example different from what is schematically illustrated in FIG. 7. For example, for some embodiments, one or more features or items illustrated in FIG. 7 may be excluded. For some embodiments, one or more additional items may be added.

With reference to FIG. 8, a third embodiment of the gas turbine power generation arrangement 800 according to the fourth aspect of the invention is schematically illustrated. Several features of the gas turbine power generation arrangement 800 of FIG. 8 may correspond to features of the gas turbine power generation arrangement 100 of FIG. 6 and to features of the gas turbine power generation arrangement 700 of FIG. 7 and are thus not described in further detail here to avoid repetition. The gas turbine power generation arrangement 800 illustrated in FIG. 8 may be described as a combination of the first and second embodiments disclosed above in connection with FIGS. 6 and 7. Further, for the gas turbine power generation arrangement 800 illustrated in FIG. 8, the one or more water fluid injector units 136a, 136b may include a second water fluid injector unit 136b for injecting water fluid into the stream 130 of a gas or gas mixture comprising oxygen downstream of the gas inlet 128 of the compressor unit 126a and upstream of the combustor unit 114a-c. Thus, the gas turbine power generation arrangement 800 of FIG. 8 includes the first and second water fluid injector units 136a, 136b, the water liquid injectors 140a, 140b, 140c and the water vapour injectors 142a, 142b, 142c.

With reference to FIG. 8, for some embodiments, the compressor unit 126a includes a gas outlet 148 for the outlet of a gas or gas mixture comprising oxygen, for example air. The combustor unit 114a-c illustrated in FIGS. 6 to 8 may be configured to receive a stream 130 of a gas or gas mixture comprising oxygen from the gas outlet 148 of the compressor unit 126a. For some embodiments, the second water fluid injector unit 136b is configured to inject water fluid into the stream 130 of a gas or gas mixture comprising oxygen downstream of the gas inlet 128 of the compressor unit 126a and upstream of the gas outlet 148 of the compressor unit 126a.

With reference to FIG. 8, it is to be understood that various features or items of the turbine power generation arrangement 800 in FIG. 8 may be arranged in various ways, for example different from what is schematically illustrated in FIG. 8. For example, for some embodiments, one or more features or items illustrated in FIG. 8 may be excluded. For some embodiments, one or more additional items may be added.

With reference to FIGS. 6 to 8, one or more of the one or more water fluid injector units 136a, 136b, one or more of the water liquid injectors 140a, 140b, 140c and/or one or more of the water vapour injectors 142a, 142b, 142c may be fluidly connected to one or more of the group of: a water fluid supply 152; a water liquid supply 154; and a water vapour supply 156. This is schematically illustrated in FIG. 6. Each supply 152, 154, 156 may comprise one or more containers holding a water fluid, for example a water liquid and/or a water vapour.

With reference to FIGS. 6 to 8, it is to be understood that for some embodiments, one or more of the one or more water fluid injector units 136a, 136b, one or more of the water liquid injectors 140a, 140b, 140c and/or one or more of the water vapour injectors 142a, 142b, 142c may be excluded. With reference to FIGS. 6 to 8, it is to be understood that for some embodiments, water vapour may be mixed with the fuel gas and/or with the gas or gas mixture comprising oxygen, or be provided thereto, in other manners different from the manners disclosed above in connection with FIGS. 6 to 8, for example introduced as water fluid and/or water liquid.

With reference to the above, and as already stated above, for some embodiments, the gas or gas mixture comprising oxygen mentioned above may comprise or consist of air. However, other gases or gas mixtures, which comprise oxygen, are possible.

With reference to FIGS. 6 to 8, although embodiments of the combustor unit 114a-c are illustrated in connection with gas turbine power generation arrangements 100, 700, 800, it is to be understood that embodiments of the method according to the first aspect and embodiments of the combustor unit 114a-c according to the second aspect, for example as disclosed above in connection with FIGS. 1 to 5, may be applied to, or incorporated in, other arrangements, plants or systems involving the combustion of a fuel gas.

The features of the different embodiments of the method, of the combustor unit 114a; 114b; 114c and of the gas turbine power generation arrangement 100, 700, 800 disclosed above may be combined in various possible ways providing further advantageous embodiments.

The present invention is not limited to the above-described embodiments. Instead, the present invention relates to, and encompasses all different embodiments being included within the scope of the independent claims.

1. A method for the combustion of a fuel gas in a combustor unit, wherein the combustor unit comprises
a first swirler,
a second swirler, and
a combustion chamber arranged downstream of the first and second swirlers,
wherein the second swirler is arranged downstream of the first swirler,
wherein the method comprises:
introducing one or more streams of fuel gas mixed with water vapour into one of the first and second swirlers while introducing one or more streams of a gas or gas mixture comprising oxygen into the other one of the first and second swirlers;
downstream of the first swirler, forming a gas stream from the one or more streams of fuel gas mixed with water vapour and the one or more streams of a gas or gas mixture comprising oxygen;
downstream of the first and second swirlers, introducing the gas stream into the combustion chamber; and
in the combustion chamber, producing a flue gas stream from at least oxygen and the fuel gas mixed with water vapour.

2. The method according to claim 1, wherein the method comprises:
introducing one or more streams of fuel gas mixed with water vapour into the first swirler while introducing one or more streams of a gas or gas mixture comprising oxygen into the second swirler.

3. The method according to claim 1, wherein the method comprises:
mixing the fuel gas with the water vapour before the introduction of the one or more streams of fuel gas mixed with the water vapour into one of the first and second swirlers.

4. The method according to claim 1, wherein the method comprises:
introducing one or more streams of a gas or gas mixture comprising oxygen mixed with water vapour into one of the first and second swirlers while introducing the one or more streams of fuel gas mixed with water vapour into the other one of the first and second swirlers.

5. The method according to claim 4, wherein the method comprises:
mixing the gas or gas mixture comprising oxygen with the water vapour before the introduction of the one or more streams of a gas or gas mixture comprising oxygen mixed with the water vapour into one of the first and second swirlers.

6. The method according to claim 1, wherein the method comprises:
producing a stream of fuel gas in a solid or liquid fuel gasifier arranged upstream of at least one of the first and second swirlers; and
producing the one or more streams of fuel gas mixed with water vapour from water vapour and said stream of fuel gas produced in the solid or liquid fuel gasifier.

7. The method according to claim 6, wherein the method comprises:
treating the fuel gas of the fuel gas stream from the solid or liquid fuel gasifier in a fuel gas treatment arrangement arranged upstream of at least one of the first and second swirlers.

8. (canceled)

9. The method according to claim 1, wherein the method comprises:
introducing the one or more streams of a gas or gas mixture comprising oxygen into one of the first and second swirlers from a compressor unit.

10. A combustor unit for the combustion of a fuel gas, wherein the combustor unit comprises
a first swirler,
a second swirler, and
a combustion chamber arranged downstream of the first and second swirlers.
wherein one of the first and second swirlers is configured to receive one or more streams of fuel gas mixed with water vapour while the other one of the first and second swirlers is configured to receive one or more streams of a gas or gas mixture comprising oxygen,
wherein the combustor unit comprises a mixing tube downstream of the first and second swirlers and upstream of the combustion chamber,
wherein the combustion chamber is configured to receive a gas stream formed from the one or more streams of fuel gas mixed with water vapour and the one or more streams of a gas or gas mixture comprising oxygen from the mixing tube, and
wherein the combustor unit is configured to produce a flue gas stream from at least oxygen and the fuel gas mixed with water vapour in the combustion chamber.

11. The combustor unit according to claim 10, wherein the combustion chamber is configured to receive a gas stream formed from the one or more streams of fuel gas mixed with water vapour and the one or more streams of a gas or gas mixture comprising oxygen.

12. The combustor unit according to claim 10, wherein the second swirler is arranged downstream of the first swirler.

13. The combustor unit according to claim 12, wherein the first swirler is configured to receive one or more streams of fuel gas mixed with water vapour, and
wherein the second swirler is configured to receive one or more streams of a gas or gas mixture comprising oxygen.

14. The combustor unit according to claim 10, wherein the first swirler is spaced apart from the second swirler.

15. The combustor unit according to claim 10, wherein the combustor unit forms a first plenum and a second plenum,
wherein the first plenum is connected to the first swirler, and
wherein the second plenum is connected to the second swirler.

16. The combustor unit according to claim 15, wherein the first plenum and the second plenum are separated from one another.

17. The combustor unit according to claim 15, wherein the first plenum and the second plenum are separated from one another by one or more walls, and wherein the one or more walls separating the first plenum and the second plenum from one another forms/form one or more openings for pressure equalization.

18. A combustor unit for the combustion of a fuel gas, wherein the combustor unit comprises
a first swirler,
a second swirler, and
a combustion chamber arranged downstream of the first and second swirlers,
wherein the combustor unit forms a first plenum and a second plenum,
wherein the first plenum is connected to the first swirler,
wherein the second plenum is connected to the second swirler,
wherein the first plenum and the second plenum are separated from one another,
wherein the combustion chamber is configured to receive one or more gas streams from the first and second swirlers, and
wherein the combustor unit is configured to produce a flue gas stream in the combustion chamber.

19. (canceled)

20. (canceled)

21. (canceled)

22. The gas turbine power generation arrangement comprising
a combustor unit according to claim 10, the combustor unit being configured to receive one or more fuel gas streams and produce a flue gas stream,
a gas expander unit for receiving the flue gas stream, and
a compressor unit for supplying a gas or gas mixture comprising oxygen to the combustor unit, the combustor unit being configured to receive one or more streams of a gas or gas mixture comprising oxygen from the compressor unit.

23. The gas turbine power generation arrangement according to claim 22, wherein the gas turbine power generation arrangement comprises a solid or liquid fuel gasifier for producing the one or more fuel gas streams.

24. The gas turbine power generation arrangement according to claim 22, wherein the gas turbine power generation arrangement comprises a fuel gas treatment arrangement for treating the fuel gas of the fuel gas stream upstream of the combustor unit, and wherein the combustor unit is configured to receive the treated fuel gas stream.

25. (canceled)
